(19) United States
(12) Patent Application Publication
(10) Pub. No.: US 2001/0036186 A1
(43) Pub. Date: Nov. 1, 2001

(54) Method and device for facilitating audio and data transmission in a networked environment

(76) Inventor: Terry O'Brien, Mission, KS (US)

Correspondence Address: Richard R. Johnson, SHOOK, HARDY & BACON L.L.P., One Kansas City Place, 1200 Main Street, Kansas City, MO, 64105-2118, US

(21) Appl. No.: 09/835,437

(22) Filed: Apr. 16, 2001

Related U.S. Application Data
(60) Provisional application No. 60/200,125, filed on Apr. 27, 2000.

(51) Int. Cl. H04L 12/66

(52) U.S. Cl. 370/395; 370/352

(57) ABSTRACT

A method is provided to facilitate the primary capabilities of both a PBX system and a LAN in addition to all standard telephone and data services. This method does not impair any of the normal functions performed by any devices found in these environments. The apparatus, system and method of this invention extends the communication control process that is traditionally provide by ATM. A method is provided for a variation in ATM structure to facilitate virtual-line. A method of the present invention allows enhanced calling features for both residential and small business telephone customers. Another method is provided for cost effective voice and data communications through usage billing as opposed to dedicated line billing. An even further method is provided for the encryption of all transmissions.

### CROSS-REFERENCE TO RELATED APPLICATIONS

This application claims the benefit of U.S. provisional application Serial No. 60/200125 filed Apr. 27, 2000.

### FIELD OF THE INVENTION

In general, the present invention relates to computer and telecommunication networks. In particular, it relates to a method and device for facilitating audio/data transmission in a networked communications environment.

### BACKGROUND OF THE INVENTION

In general, a private telephone switchboard, otherwise known as a Private Branch Exchange system (PBX), and Local Area Networks (LAN) are operated as two separate and independent systems. A physical wire pair is typically allocated to each channel of communication and an end customer typically pays “by the line”. This means that a customer is billed even if the line is never used. A variation of an Asynchronous Transmission Mode system (ATM) can provide for both PBX and LAN capabilities.

PBX networks are known. Typical PBX systems consist of multiple telephone extensions that are multiplexed to an outside telephone network. The PBX functions as a central point for calls that are received or made from the telephone extensions. Essentially, this allows each external network line to be shared by many extensions. A PBX also enables a user at one of the extensions to use features offered by the PBX with another user at another extension on the PBX.

A PBX suffers from several disadvantages, however. First, a PBX is limited to providing PBX features to only the users with extensions on the PBX and not to any outside callers. Second, PBX features require a user to memorize the various keystrokes required to initiate the features. Finally, PBX systems generally require the use of proprietary equipment which can be an added cost and above all introduce compatibility problems between PBX systems.

A LAN provides connectivity to a plurality of devices that share a transmission medium. A LAN includes multiple segments each of which comprises a shared transmission medium and a plurality of stations connected to the medium. A hub(repeater) may also be connected to the transmission medium to provide connectivity between different LAN segments and their associated stations. A LAN segment is connected to a Wide Area Network via a gateway. Any one of the stations on a LAN can serve as a source of audio/video multicast. A subset of the other stations are then able to receive the multicast.

Illustratively, a multicast is a communication in which data is broadcast from a source station to a plurality of receiving stations. Each of the receiving stations then decides if it will to participate in the multicast. The source of a multicast may be a station in a first segment and the multicast may be transmitted into a second segment via the hub. The source of the live multicast may also be entirely outside the LAN and may be transmitted into the segment via the gateway.

ATM is a cell-based switching and multiplexing technology. ATM is designed as a general purpose connection oriented transfer mode for a variety of services including Local Area Networks (LAN) and Wide Area Networks (WAN). ATM offers a seamless integration of communication and networking applications such as, voice, data and video traffic. ATM can handle both connection-oriented traffic and connectionless traffic. The switching and multiplexing methods that can be supported by ATM provide the ability to support a wide range of services. This switching capability is similar to the operation of a PBX. However, the ATM extends this capability beyond a fixed number of user extersions. The ATM methods are extendable and available to all point-to-point and point-to-multipoint devices that share the same ATM leaf.

Accordingly, there exists a need to provide a variation in ATM service structure to facilitate the primary capabilities of both a PBX and a LAN. In addition to all standard telephone and data services provided by the standard ATM, the present invention provides a system and method for extending the capabilities of ATM to a combination of telecommunication and computer devices.

### SUMMARY OF THE INVENTION

Generally described, a method is provided for a variation in ATM service structure that will facilitate the primary capabilities of both a PBX system and a LAN in addition to all standard telephone and data services. This method does not impair any of the normal functions performed by any devices found in these environments. Instead, the apparatus, system and method of this invention extends the communication control process that is traditionally provide by ATM. The Invention is applicable in an environment where a user may need to perform multiple communications activities with limited physical resources both securely and cost effectively.

A method is provided for a variation in ATM structure that will also facilitate virtual-line communication such that the physical allocation of a wire pair for each channel of communication for telephones to the ATM will not be necessary.

A method is provided to allow enhanced calling features for both residential and small business telephone customers.

A method is provided for cost effective voice and data communications through usage billing as opposed to dedicated line billing.

A method is provided for the encryption of all transmissions.

### BRIEF DESCRIPTION OF THE DRAWINGS

The present invention is described in detail below with references to the attached drawing figures, where in:

FIG. 1 is a block diagram illustrative of a communication network suitable for use in implementing the present invention.

FIG. 2 is a block diagram illustrative of another embodiment of a communication network suitable for use in implementing the present invention.

FIG. 3 is a diagram of a typical communications application for the inventive method.

FIG. 4 is a block diagram of the components of a terminal in accordance with the present invention.

FIG. 5 is a block diagram illustrating two possible packeting methods of audio and video cells for use in the present invention.

### DETAILED DESCRIPTION OF THE INVENTION

The present invention provides a method and system for facilitating audio and data transmission in an open-ended computing system having a plurality of networked terminals or devices. The invention is operable with numerous general or special purpose communications and computing systems. Examples of well known computing systems that may be suitable for use with the invention include personal computers, server computers, note-book computers, hand-held or laptop devices, multiprocessor systems, networked personal computers, minicomputers, and mainframe computers. Communications systems that may be suitable for use with the invention include telephones, portable communications units, personal digital assistants, and single chip telephones. As would be readily understood by someone skilled in the relevant art, additional or alternative communications/computing environments or components are within the scope of the present invention.

For the purpose of clarity, the term “LN16” will be used to refer to the combination hardware and software hub device that serves as an ATM leaf node and provides the connectivity and processing functions described by this invention.

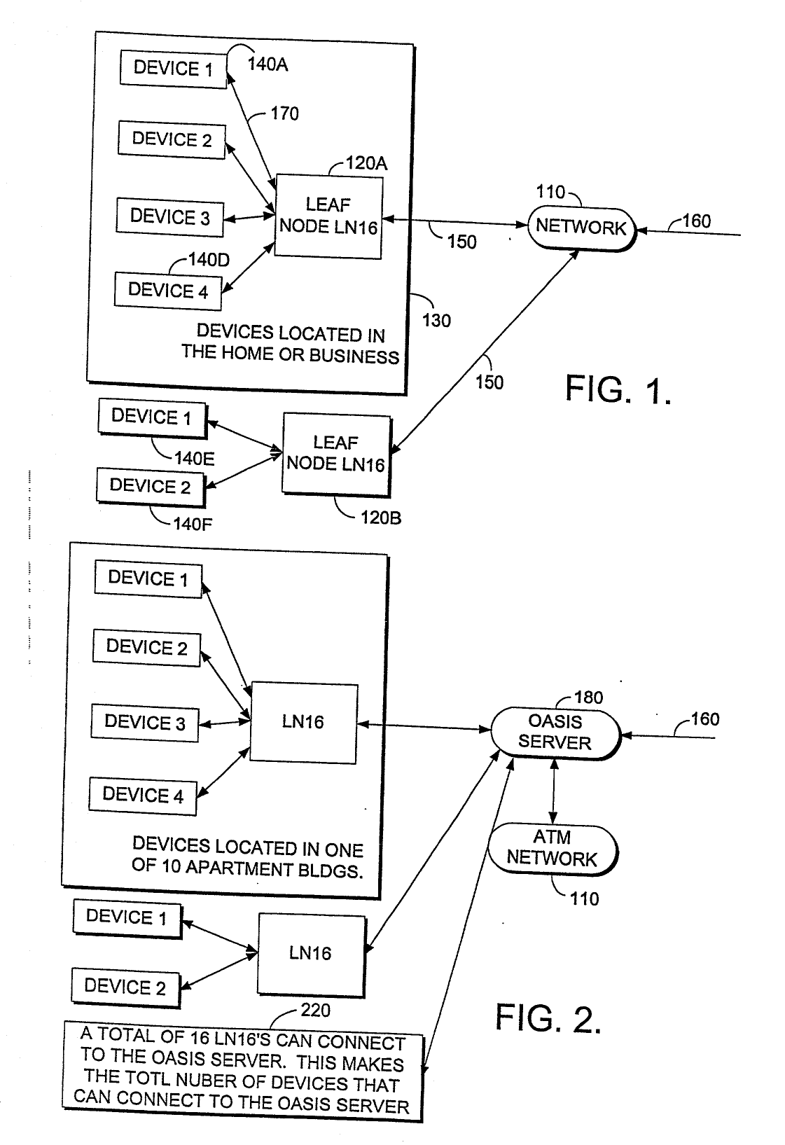

In order to practice the methods in this invention it is necessary to have a network of devices and a hub (“LN16”) device that is capable of multiplexing, accepting multiple device connections, encryption, bill tracking, security and audio/visual data manipulation. The LN16, and other devices, must be connected in the proper configuration. FIG. 1 is a block diagram of a communication network of the present invention designated generally by the reference number 100. The network, as shown, includes a Trunk line (“T1”) 160 that provides the connection of an ATM network to the rest of the world; a network connection 150 from the ATM network to the Leaf Node LN16 120; and a plurality of devices 140 connected to the LN16. The communication from the LN16 to the device 140 is independent of the communication 150 from the LN16 to the Network 110. Network communication 150 is synchronous and occurs at the same data rate, while device communication 170 can be synchronous or asynchronous and can operate over a wide range of data rates. The devices 140 attached to LN16 may function at varying ranges of band width depending on a preset device specific configuration. This allows each device to utilize just the amount of band width that it requires rather than a larger preset quantity that will apply to all devices. This will improve the efficiency of the communication. The LN16 operates in a deterministic mode. Therefore it is required that any new devices that attach to the network must be interrogated by the LN16 and subsequently assigned a time slot in the network protocol. As shown in FIG. 1, there can be multiple LN16 devices connected to the ATM network. Each LN16 120 operates as a hub and can support up to 16 individual devices 140 operating in a star configuration. Typically, LN16 devices 120 are located in a home or business where the devices 140 can be found and where there is a need to securely transmit a variety of data from multiple source devices.

In another embodiment of the present invention, the LN16 120 can be connected to the ATM network 110 via an OASIS server 180. The OASIS server is described in another patent application XXXXX and is generally used to host applications to other connected devices known as End Point Devices. This configuration is shown in FIG. 2. As can be seen in FIG. 2, the connection of the End Point Devices 140 to the OASIS server 180 is via an LN16 120. The OASIS server 180 combines the signals from each LN16 120 into a common format prior to connection to the ATM 110. Essentially, the OASIS server 180 extends the capabilities of the LAN and PBX such that the functions provided in those environments can be extended to any device that seats behind the OASIS server 180. In other words, devices 140 that are connected to different LN 16's 120 can intercommunicate and use features that are unique to a particular leaf across the LAN to any other devices that are connected to a common OASIS server. An OASIS server can support up to 16 of the LN16s 120 and all of their associated devices 140. Preferably, the communication network 150 includes a LAN, such as an Ethernet link, which provides each device 140 access to the LN16 device 120. As would be readily understood, the communication network 150 may also encompass WAN's; Telephonic lines; or a combination of various network configurations. The type of devices referred to in this paragraph can be of various forms, such as computers or telephones. This will be discussed in detail later on in this document.

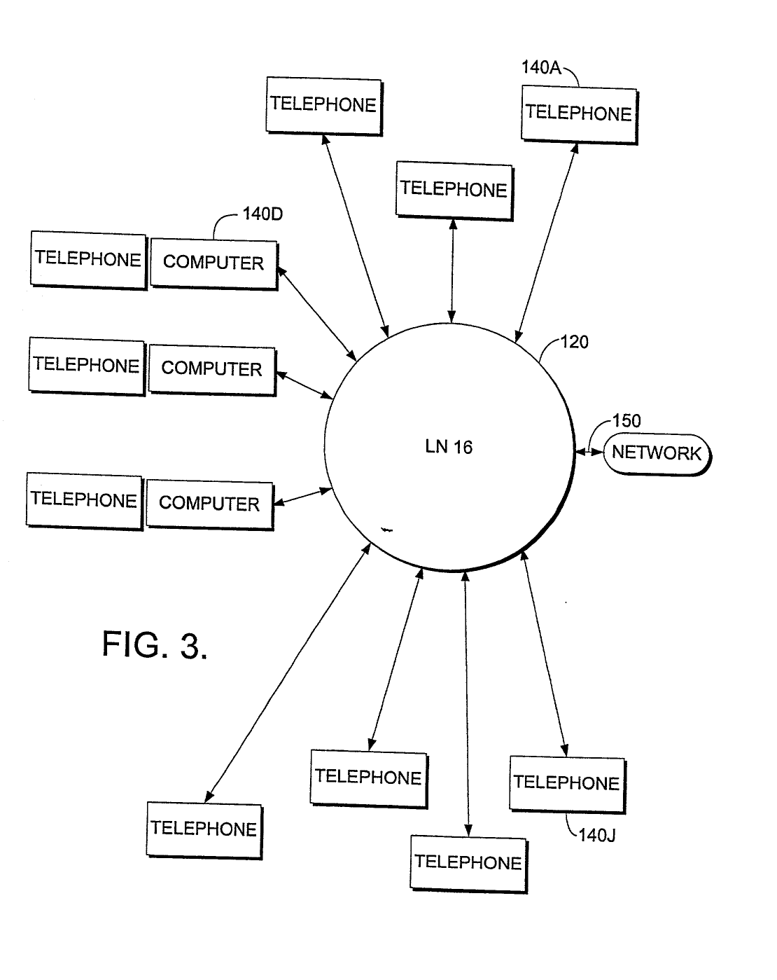

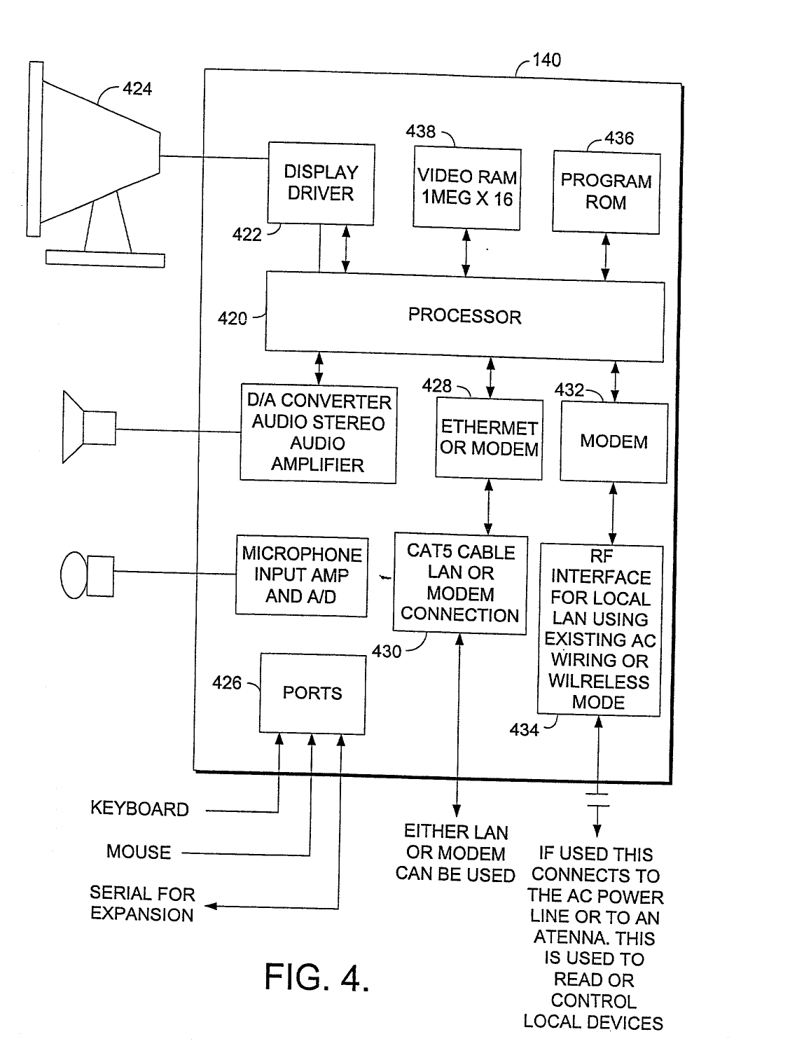

A typical application utilizing LN16 120 is shown in FIG. 3, As previously mentioned, the device 140 can be either a computer system or a telecommunications system. It should be noted that a single LN16 can have a variety of devices 140 simultaneously connected, such as computer systems or telephones as shown in FIG. 3. The communications between the devices and the LN16 is bidirectional, as is the communication between the LN 16 and any upstream device, such as an ATM Network 110 or OASIS server 180. A user is provided with the ability to exchange files, video or communicate in real time. In order for this communication to take place there are some minimal component requirements as illustrated in FIG. 4.

FIG. 4 is a block diagram representative of a preferred computer system device 140 in accordance with the present invention. The device depicted in FIG. 4 can be implemented on a single silicon die. With reference to FIG. 4, each device 140 preferably includes a processor 420 having a minimal memory component 436; a communications device, such as a 10/100 Base T network interface 428 or modem interface 432; a video display driver 422; a terminal display 424; and one or more input devices such as a mouse or a keyboard connected to a port 426. Additionally, the device 140 can have a connection for a 10/100 Base T type CAT 5 or modem communication connector 430. In an alternative embodiment of the present invention the device 140 can have a Modem 432 that is connect to a RF interface for a LAN 434 for utilizing either existing AC wiring or wireless communications. Apart from the potential hardware configuration discussed so far, the methods of the present invention can also be implemented by software algorithms.

In an alternative embodiment of the present invention, a device 140 may be a conventional personal computer (“PC”). A PC would typically have the above-listed components as well as additional components for supporting an independent operating environment. In this alternative embodiment, the PC terminal would emulate the preferred device 140 by executing a special program and would also be able to function as a stand-alone PC. This alternative embodiment allows the network of the present invention, with some minor software modifications, to accommodate alternative or pre-existing computing systems in the general network 170 as shown in FIG. 1.

The communication from the LN16 120 to the ATM 110 occurs at a constant data rate with fixed size packets known as Cells. Each Cell carries a payload of data from a specific device 140. The number of Cells is directly proportional to the number of devices 140 attached to a LN16 120. The ATM automatically assigns an address for use by the LN16 using a Dynamic Host Configuration Protocol (“DHCP”). At power up an LN16 requests an address which is then sent to the LN16 by the ATM. An ATM operates by establishing a path from an originating device to a destination device. Consequently, this requires that all intermediate ATM devices have the necessary information to maintain the path during the existence of the communication between the pair of devices. In addition, since an established path does not need to be updated, all subsequent transmissions do not need to carry information on destination, origin, or connection thereby enhancing the communications speed.

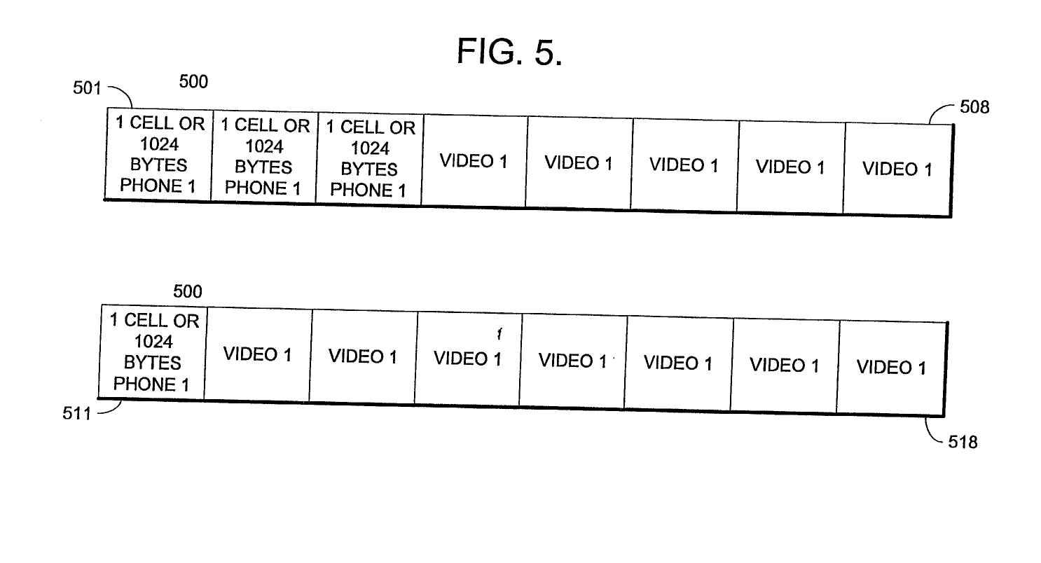

During a communication session the data received from each device that is connected to the LN16 is accumulated until enough data exists to fill a Cell. It should be noted that the size of a Cell may be configured. However, the selected Cell size will apply to all Cells for a particular LN16. In a preferred embodiment of this invention, the Cell size is configured to be 1024 Bytes and the data link between the LN16 and the ATM operates at 10 Mbps. Thus, it takes about 1 millisecond to transfer data from each Cell (8096 bits+protocol overhead at 10 Mbps). Any single device can use a maximum of 8 Cells. A single LN16 can support up to 16 devices. Therefore it will take about 128 ms to send all the information for all devices attached to one LN16. The Cell requirement of a given device is dictated by the specific need of that particular device and may vary for each of the devices connected to a single LN16. A telephone, for example, frequently requires multiple channels where a channel is the equivalent of a phone line. During a call which has already established a connection, the receipt of an incoming call to the same device will require a different channel, i.e. placing the existing call on hold and accepting the new call. To place both existing calls on hold and make or accept another call will require a third channel. This process may continue until all the allocated channels for that device have been utilized. The channel limitation for a device eliminates the potential of a device using more bandwidth than allowable for the system to operate within its performance specifications. It is likely that a device that combines audio and video will utilize the full capacity of 8 channels. Typically, the channels for a particular device are allocated based on priority. For example, in FIG. 5A, an allocation of 8 channels is shown for a device wherein the 3 audio channels 501-503 are given priority over the remaining 5 video channels 504-508. In FIG. 5B, there is a single audio channel 511 that has priority over the remaining 7 video channels 512-518. The device in these examples is a video phone. The order of the Cells allocated to a communication function determines the priority of that communication. Furthermore, each Cell that is allocated to audio communication essentially creates a virtual line of communication. Therefore, in FIG. 5A there are 3 virtual lines in use and in FIG 5B there is one virtual line in use. It should be noted that as more audio Cells are used by the device, it reduces the number of Cells available for video. However, the number of audio paths used by one device has no effect on other devices since the usage will in no way impact the pre-allocated bandwidth of 8 Cells per device.

When a device first attempts to communicate with an LN16 it must establish a data rate through a process of port synchronization. The first step in port sychronization is to establish a maximum data rate for the LN16. The maximum data rate is established by a sample rate. This is the rate at which each of the 16 ports available on the LN16 can be sampled on every clock cycle (“Pclk”).

The present invention uses a Pclk of One Megahertz which translates to a data rate of one megabit per second. Much higher data rates can be established with a similar design by increasing Pclk. During port synchronization, any connected device continuously outputs the value Hex 55 with no start or stop bits to the serial interface port. This essentially creates a continuous 01010101 at the data port input of the LN16. The frequency of the alternating one-zero input establishes the data rate that is desired by the device connected to the LN16. Once this rate is determined by the LN16 a data rate acknowledgment signal is sent by the LN16 to complete the synchronization process. It should be noted that new data rates (“re-sync”) can be established either by the device or by the LN16. In either case, a port synchronization, such as the one described earlier, would be required. A re-sync pertains to any or all devices when the re-sync is initiated by the LN16, otherwise it only pertains to the requesting device.

The present invention further includes a preferred method of facilitating the transfer and receipt of data between two or more devices without compromising the security of the communication. In one embodiment of this invention the system can be implemented by the use of an encryption method that utilizes a Key. The LN16 is able to encrypt all transmissions such that all audio and/or video data is unintelligible without a Key.

In general, encryption entails the method of altering data by a succession of logical or mathematical operations prior to sending the information across the network or other communication medium. The first stage is the creation of data packets to which the encryption algorithm will be applied. Encryption renders the data meaningless until the necessary operations are performed to restore the data to its original form. The encrypted data is sent over some communication medium to a Recipient Device. In order to facilitate the decryption of the information on the recipient end, a Key, or in other words, the mathematical expression that will negate the operations performed to encrypt the data, must be communicated to the recipient device.

In an embodiment of this invention, a Key is a randomly generated sequence of digits. The digit sequence is used to logically modify each byte of data during any communication session. As is known in the field, the logical operations performed on the data bytes can include such actions as Exclusive-Or (“XOR”) and Shifting of the data before it is packetized and sent out over the ATM. Since these operations are order dependent, a receiving device on the ATM will not be able to produce intelligible audio or video without the same Key being entered into the device to allow the previously performed logical operations to be negated. The random number Key is sent to the receiving LN16 as part of the initial path and channel acquisition. This method generally requires no operations by the user and provides a measure of security that is sufficient in most cases. For the transmission of more sensitive data, such as credit card numbers or other commerce related information, more comprehensive methods of security should be employed. The concept and details of various methodologies for securely transmitting data including encoding, decoding and generation/transmission of a Key, will not be discussed in any great depth as it is the subject of a separate application for letters patent titled ‘Method and Device for Implementing Secured Data Transmission In a Networked Environment’, the entirety of which is hereby incorporated by reference herein.

In another aspect of the present invention, the LN16 provides a ‘plug and play’ operation for devices that connect to the LN16 by eliminating any manual setup or user configuration. For instance, the process of synchronization determines and sets the values for variable parameters that would normally require user configuration or input.

In yet another aspect of the present invention, the LN16 provides for cost effective voice and data communications. Generally, a user must anticipate the maximum number of communication lines that they will need and thus pay for that many dedicated lines at all times. The LN16 allows a user to be billed for the usage of communications lines rather than being billed for a large number of dedicated lines. In other words, a customer will not have to pay for a line unless it is actually in use. This enables the user to have access to multiple virtual lines as needed. The present invention tracks the usage of each device that is serviced by an LN16 and counts the number of Cells that each device utilizes over the ATM. This allows an overall cost to be determined as well as individual device costs. The use of virtual lines provides a lower cost than the dedicated line equivalent.

As would be generally understood, there are additional applications of the present invention that would benefit from the data handling and processing methods of the present invention. All of these are considered within the scope of the present invention.

We claim:

1. A system for facilitating audio/video and data transmission in a networked environment comprising:
a hub;
a plurality of devices connected to said hub; and
a connection of said hub to an ATM network or other network server to facilitate the primary capabilities of both a PBX and a LAN.

2. A system as recited in claim 1 wherein said device is a computer system having a processor, a memory, a communication device, a network interface, a user display, and one or more input devices.

3. A system as recited in claim 1 wherein said device is a telephonic device.

4. A system as in claim 1 wherein said hub is a multiplexer.

5. A system as in claim 1 wherein said hub is a combination of hardware and software comprising:
a plurality of ports for connection of said devices;
a port for connection of said hub to a network or server; and
means for executing algorithms.

6. As system as in claim 5 wherein said algorithms enable said hub to multiplex, encrypt/decrypt data, package data, track system utilization and support the connection of multiple dissimilar said devices.

7. A method for secure communication using a hub comprising the steps of:
bundling information into a plurality of message packages; and
executing algorithms for encryption and decryption.

8. A method for communication between a hub and an ATM wherein said communication occurs at a constant rate of speed for a Cell and wherein said Cell is a fixed size package of data.

9. A method as in recited in claim 8 wherein said Cell carries data from a specific device.

10. A method as recited in claim 9 wherein the total number of said Cell is directly proportional to the number of said devices that are attached to said hub.

11. A method for communicating voice data on a virtual communication line comprising the steps of:
multiplexing and compressing signals to enable the use of fewer communication lines; and
allocating a plurality of Cells for each communications device.

12. A method as recited in claim 11, wherein said Cells have the same or varying destinations in a communication session and said Cells are further allocated to support video and/or audio content.

13. A method as recited in claim 11 wherein said communication comprises the steps of:
transmitting a video image in a video Cell; and
transmitting audio data in an audio Cell.

14. A method as recited in claim 12 wherein said communication session comprises a combination of audio and video Cells, wherein each audio Cell has a single and separate destination on a network and each video may have as many destinations as there are audio Cell destinations.

15. A method for providing enhanced calling features to users of a plurality of devices that are connected on a network wherein said devices are connected to a hub that is connected to an ATM directly or through a server

16. A method as recited in claim 15 wherein said devices are connected through a server to a plurality of said hub thus enabling enhanced calling features between all devices downstream of the server.

17. A method for reducing the cost of multiple communication lines comprising the steps of:
tracking line usage;
tracking the number of Cells that each device sends across the ATM; and
creating virtual lines of communication for said Cells within each device.

18. A method of securing a phone and/or a video communication in a network comprising:
encryption of all audio and/or video transmissions;
generation of a Key to modify audio/video data; and
sending said Key to a receiving hub as part of the transmission.

19. A method for providing ‘plug and play’ operation for a device connected in a network comprising the steps of:
synchronizing communication between the hub and said device; and
automatically configuring the dynamic properties required for said device.

20. A computer readable storage medium having stored thereon a computer program comprising one or more instructions for implementing the steps recited in claim 7.

21. A computer readable storage medium having stored thereon a computer program comprising one or more instructions for implementing the steps recited in claim 8.

22. A computer readable storage medium having stored thereon a computer program comprising one or more instructions for implementing the steps recited in claim 11.

23. A computer readable storage medium having stored thereon a computer program comprising one or more instructions for implementing the steps recited in claim 15.

24. A computer readable storage medium having stored thereon a computer program comprising one or more instructions for implementing the steps recited in claim 17.

25. A computer readable storage medium having stored thereon a computer program comprising one or more instructions for implementing the steps recited in claim 18.

26. A computer readable storage medium having stored thereon a computer program comprising one or more instructions for implementing the steps recited in claim 19.
